(19) United States
(12) Patent Application Publication
(10) Pub. No.: US 2020/0282674 A1
(43) Pub. Date: Sep. 10, 2020

(54) PULTRUSION METHOD FOR PRODUCING FIBRE-REINFORCED PLASTIC PROFILED SECTIONS AND PULTRUSION DEVICE

(71) Applicants: COVESTRO DEUTSCHLAND AG, Leverkusen (DE); KRAUSMAFFEI TECHNOLOGIES GMBH, München (DE)

(72) Inventors: Benedikt Kilian, Düsseldorf (DE); Dirk Bruening, Leverkusen (DE); Jochen Remmel, Leverkusen (DE)

(21) Appl. No.: 16/652,441

(22) PCT Filed: Oct. 2, 2018
(86) PCT No.: PCT/EP2018/076832

§ 371 Date: Mar. 31, 2020

(30) Foreign Application Priority Data
Oct. 6, 2017 (EP) 17195206.2

(51) Int. Cl. B29C 70/52

(52) U.S. Cl. CPC B29C 70/523; B29C 70/528

(57) ABSTRACT

The invention relates to a pultrusion method for producing fibre-reinforced plastic profiled sections and to a pultrusion device.

The invention relates to a pultrusion process for the production of fiber-reinforced plastics profiles, and to a pultrusion device.

Pultrusion processes for the production of fiber-reinforced plastics profiles are known per se, and are used for the production of numerous different profiles in various application sectors, for example in the construction industry (for example for window frames and door frames), in electrical equipment (for example cable ducts), and also in consumer products (for example sports equipment). Pultrusion processes usually use a plastic (for example a molten thermoplastic, for example polypropylene, or a liquid reactive resin, for example polyurethane) for continuous impregnation of reinforcement fibers (for example glass fibers or carbon fibers) which take the form of continuous-filament fibers, of continuous-filament-fiber bundles (rovings), or of semifinished textile products, and then draw said reinforcement fibers through a temperature-controllable die in which the final profiling takes place and the plastic is solidified.

Pultrusion processes for the continuous production of fiber-reinforced profiles with polyurethane matrix usually use injection boxes for the impregnation of the reinforcement fibers. The literature contains many descriptions of injection boxes. In order to increase pressure and to assist flow of the liquid polyurethane mixture into the reinforcement fibers, the known injection boxes traditionally have a conical shape which narrows in production direction until the final profile cross section is reached. Complete impregnation of the reinforcement fibers, and thus maximized quality of the resultant profiles, can thus be achieved.

By way of example, therefore, EP 712716 A1 describes a process, and also an associated extrusion-impregnation device, where profiles are produced by using an impregnation zone providing damped oscillation. The height of the impregnation channel of the device can moreover be adjusted during operation.

The process described using the injection box has the disadvantage that the parameters usually prescribed for the procedure and for raw materials generate, within the injection box, a pressure which is not amenable to any external influence. By way of example, if the production speed is increased stepwise at the start of the production process, a pressure is established which is a function of the prescribed speed and which is sometimes too low or too high. If, during the course of the production process, it is desirable to change the reactive resin (for example to a reactive resin with higher viscosity), or to increase filler content or fiber content, the result of this in the injection box is then automatically a different pressure, which likewise can sometimes be too low or too high.

It was therefore an object of the present invention to provide a process, and also a device, that can avoid the abovementioned disadvantages.

Surprisingly, it has been found that the pultrusion process described in more detail below, and also the pultrusion device, avoids the abovementioned disadvantages in that the pressure in the injection box can be adjusted during operation by altering the aperture angle.

The present application provides a pultrusion process for the impregnation of continuous-filament fibers, of continuous-filament-fiber bundles (rovings), or of semifinished textile products (1) by means of molten thermoplastic or by means of liquid reactive resin (10), for the production of fiber-reinforced profiles, where
i) the continuous-filament fibers, the continuous-filament-fiber bundles, or the semifinished textile products (1) are drawn into and through an enclosed channel (2) of an injection box (3),
ii) in order to saturate the continuous-filament fibers, the continuous-filament-fiber bundles, or the semifinished textile products (1), the molten thermoplastic or the liquid reactive resin (10) is charged through one or more apertures (8) into the channel (2) of the injection box (3),
iii) in order to cool the molten thermoplastic, or in order to harden the reactive resin (10), with formation of the fiber-reinforced profile, the saturated continuous-filament fibers, continuous-filament-fiber bundles, or semifinished textile products (1) are drawn out from the enclosed channel (2) of the injection box (3) into a chamber (4) of a temperature-controllable die (10),
iv) the fiber-reinforced profile is drawn out from the chamber (4), which is characterized in that

the internal pressure (p) in the region of the discharge aperture (5) of the channel (2) is adjusted by altering the cross section of the entry aperture (6) of the channel (2), by varying the set angle (α, α′) of at least one of the walls of the channel (2) in relation to the vertical plane (7) of the discharge aperture (5).

The process of the invention permits ideal continuous production of the fiber-reinforced profiles at constant pressure and, for example, change of pultrusion speed if necessary during the process, response to changed ambient conditions, for example room temperature, and change of reactive resin during the course of operation.

For implementation of the process of the invention, the design of the injection box used in the pultrusion process can by way of example be such that the cross section of the entry aperture (6) of the channel of the injection box can be altered by virtue of the variability of the set angle (α, α′) of at least one of the walls of the channel in relation to the vertical plane (7) of the discharge aperture.

A defined internal pressure becomes established in the injection box as a function of the parameters of the procedure (for example production speed and injection-box temperature), and also of the raw material parameters (for example reaction-resin viscosity and filler content). The internal pressure is also influenced by the set angle in the injection box.

For a stable production procedure, and in order to produce profiles with good quality, it is therefore important to optimize pressure in the injection box: in order to achieve complete saturation of the reinforcement fibers, the pressure in the injection box is not permitted to be excessively low. On the other hand, in order to avoid adverse effects on the stability of the procedure, the pressure in the injection box is also not permitted to become excessively high. This is achieved via the set angle.

The present application also provides a pultrusion device for the impregnation of continuous-filament fibers, of continuous-filament-fiber bundles (rovings), or of semifinished textile products (1) by means of molten thermoplastic or by means of liquid reactive resin (10), for the production of fiber-reinforced profiles, which comprises an injection box (3) made of at least two die halves (9, 9′) with an enclosed channel (2) formed by the at least two die halves (9, 9′) and having an entry aperture (6) and a discharge aperture (5), and comprises, attached to the discharge aperture of the channel, a chamber (4) of a temperature-controllable die, where the cross section of the entry aperture (6) of the channel can be altered by virtue of the variability of the set angle (α, α′) of at least one of the walls of the channel in relation to the vertical plane (7) of the discharge aperture.

Examples of semifinished textile products are woven fabrics, laid scrims and fiber mats.

The internal pressure (p) is the pressure present at the discharge aperture (5).

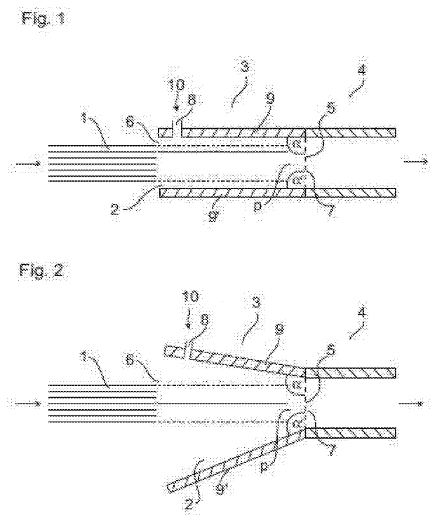

FIG. 1 depicts a cross section of a portion of a pultrusion system. The continuous-filament fibers, continuous-filament-fiber bundles (rovings), or semifinished textile products 1 are drawn into the entry aperture 6 of the channel 2 of an injection box 3 made of two die halves 9 and 9′, and drawn through the discharge aperture 5 of the channel 2 into a chamber of a die. Molten thermoplastic or liquid reactive resin 10 is charged into the channel 2 by way of at least one aperture 8.

FIG. 2 is likewise a cross section, differing from FIG. 1 in that the angles α, α′ have different values.

The invention will be explained in more detail with reference to the examples below.

### EXAMPLE

A polyurethane system comprising the following mixture as polyol component was used as matrix material:

62.20% by weight of a glycerol-started polyether polyol based on propylene oxide, hydroxy number (OH number)=400 mg KOH/g

11.00% by weight of glycerol

10.00% by weight of a propylene-glycol-started polyether polyol based on propylene oxide, hydroxy number (OH number)=515 mg KOH/g

12.00% by weight of a propylene-glycol-started polyether polyol based on propylene oxide/ethylene oxide, hydroxy number (OH number)=57 mg KOH/g

0.80% by weight of diisooctyl 2,2′-[(dioctylstannylene)bis(thio)]diacetate (catalyst)

4.00% by weight of MOLSIV® L paste (50% dispersion of MOLSIV® L powder in castor oil) from UOP (water binder)

4 parts by weight of Luvotrent® TL HB 550 (release agent from Lehmann & Voss) were admixed, and vigorously stirred, with 100 parts by weight of the abovementioned component.

A mixing and metering system was used to mix this mixture with a polymeric diphenylmethane diisocyanate (MDI) with NCO content 32.0% by weight (comprising 69% by weight of monomeric MDI with content of 2,4′-MDI and 2,2′-MDI totaling 8% by weight) in a mixing ratio such that the isocyanate index was 114.

Unidirectional glassfiber rovings were used as reinforcement fibers. Fiber content in the resultant profile was about 90% by weight.

A rectangular profile (60 mm×5 mm) was produced. A pultrusion die of length 1 m was used. In pultrusion direction, the die had three heating zones, controlled to temperatures of 160° C./180° C./190° C. (with aperture angle 90.7°) and, respectively, 150° C./170° C./180° C. (with aperture angle 91.6°).

An injection box with aperture angle α and α′ 90.7° for each injection-box half (above/below) was used. A production speed of 0.5 m/min (e.g. start-up of the system) generated a pressure p=27.2 bar at the end of the injection box. Take-off force F was 0.1 t. Production speed was increased to 1.1 m/min (e.g. for production of profiles). The pressure increased to p=38.0 bar, and the force increased to F=1.8 t. This increase of pressure and of take-off force was critical, because the procedure became unstable and had to be terminated.

Change of the angle α and α′ of the injection box to 91.6° for each injection-box half (above/below) reduced both the pressure and the take-off force significantly. The established production speed of 1.1 m/min generated a pressure of p=10.2 bar and a force of F=0.1 t.

Appropriate adjustment of the aperture angle α and α′ permitted stable implementation of the procedure without problems, even at this relatively high production speed.

1. A pultrusion process for the production of fiber-reinforced profiles, comprising:
impregnating continuous-filament fibers, continuous-filament-fiber bundles, or semifinished textile products with molten thermoplastic or liquid reactive resin to form a fiber-reinforced profile, wherein the process further comprises
i) drawing the continuous-filament fibers, the continuous-filament-fiber bundles, or the semifinished textile products into and through an enclosed channel of an injection box,
ii) charging the enclosed channel of the injection box with molten thermoplastic or liquid reactive resin to form saturated continuous-filament fibers, continuous-filament-fiber bundles, or semifinished textile products,
iii) drawing the saturated continuous-filament fibers, continuous-filament-fiber bundles, or semifinished textile products out from the enclosed channel of the injection box into a chamber of a temperature-controllable die to cool the molten thermoplastic, or harden the reactive resin to form the fiber-reinforced profile, and
iv) drawing the fiber-reinforced profile out from the chamber,
wherein an internal pressure in a region of a discharge aperture of the channel is adjusted by altering a cross section of an entry aperture of the channel, by varying a set angle of at least one of wall of the channel (2) in relation to a vertical plane of the discharge aperture.

2. The process as claimed in claim 1, wherein adjustment of the angle is achieved automatically via pressure-dependent control.

3. A pultrusion device for the production of fiber-reinforced profiles by impregnation of continuous-filament fibers, continuous-filament-fiber bundles, or semifinished textile products with molten thermoplastic or liquid reactive resin comprising:
an injection box comprising at least two die halves forming an enclosed channel having an entry aperture and a discharge aperture, and further comprising a chamber of a temperature-controllable die attached to the discharge aperture of the channel, wherein
a cross section of the entry aperture of the channel is alterable by virtue of a variability of a set angle of at least one wall of the channel in relation to a vertical plane of the discharge aperture.
